(19) United States
(12) Patent Application Publication
(10) Pub. No.: US 2026/0261630 A1
(43) Pub. Date: Sep. 3, 2026

(54) System, Device, Method, and Program for Detecting Target Approaching Movable Body

(71) Applicant: Konica Minolta, Inc., Tokyo (JP)

(72) Inventors: Noriaki ASAMOTO, Kusatsu-shi, Shiga (JP); Junichi HASE, Osaka-shi, Osaka (JP)

(21) Appl. No.: 19/162,184

(22) PCT Filed: Feb. 28, 2024
(86) PCT No.: PCT/JP2024/007272

§ 371 Date: Sep. 4, 2025

(30) Foreign Application Priority Data
Mar. 8, 2023 (JP) 2023-035396

(51) Int. Cl. H04N 7/18; G06V 20/58

(52) U.S. Cl. CPC H04N 7/183; G06V 20/58

(57) ABSTRACT

Entry of a target is detected within a certain range from a movable body as a detection range even when the posture of the movable body is changed. A system includes: an imaging device provided at a movable body; a processor that is configured to: set a detection range for a target on an image acquired from the imaging device; detect a change in a posture of the imaging device or the movable body; detect entry of the target into the detection range; and output the image and the detection range. The processor changes the detection range on the image based on the change in the posture of the imaging device or the movable body.

### TECHNOLOGICAL FIELD

The present disclosure relates to a system for detecting a target approaching a movable body, more specifically, to a detection range adjustment technique.

### BACKGROUND

In a factory or the like, a movable body such as a forklift is used. In the factory, a person, an AMR (Autonomous Mobile Robot), and the like may work. Contact of the movable body with the person, the AMR, and the like leads to an accident. Therefore, an operator who operates the movable body needs to monitor whether or not the person, the AMR, or the like, i.e., a monitoring target, has approached the movable body.

A fish-eye lens camera or the like may be used for safety confirmation around the movable body. For example, there has been known a technique in which an image captured by the fish-eye lens camera is analyzed and an alert is output based on entry of the monitoring target such as the person or the AMR into a certain range around the movable body.

In order to detect the target approaching the periphery of the movable body, a TOF (Time of Flight) sensor, a LIDAR (Light Detection And Ranging), or the like is generally used. However, the TOF sensor is inexpensive, but may not be able to normally detect the target due to an influence of disturbance light. On the other hand, the LIDAR is very expensive. Furthermore, each of these sensors cannot recognize the attribute and movement speed of the target approaching the movable body. Therefore, in order to detect the attribute, movement speed, and the like of the target, an imaging device is additionally required. In addition, a stereo camera that can measure a distance from an imaging position to the target is known. However, the stereo camera has a limited angle of view and is not suitable for use in capturing an image of the entire surroundings of the movable body. Therefore, there has been required a less expensive technique for effectively confirming safety around the movable body.

Regarding the technique for confirming safety around the movable body, for example, Japanese Laid-Open Patent Publication No. 2021-139283 (PTL 1) discloses a detection system “including: a stereo camera provided on a heavy machine at a rear portion of the heavy machine so as to capture an image of the rear portion of the heavy machine; a monitor that displays the image captured by the stereo camera; an alarm; and a control device that controls the stereo camera, the monitor, and the alarm, wherein the control device changes a level of alarming by the alarm in accordance with positions or the number of workers detected from the image captured by the stereo camera” (see [Abstract]).

On the other hand, PTL 2 discloses a technique for detecting entry of a target into a certain area, for example.

### CITATION LIST

### Patent Literature

PTL 1: Japanese Laid-Open Patent Publication No. 2021-139283
PTL 2: Japanese Laid-Open Patent Publication No. 2020-017131

### SUMMARY

### Technical Problem

According to each of the techniques disclosed in PTL 1 and PTL 2, when the posture of the movable body is changed, the entry of the target cannot be detected within the certain range from the movable body as the detection range. Therefore, there has been required a technique for detecting entry of a target within a certain range from a movable body as a detection range even when the posture of the movable body is changed.

The present disclosure has been made in view of the above-described background, and an object in a certain aspect is to provide a technique for detecting entry of a target within a certain range from a movable body as a detection range even when the posture of the movable body is changed.

### Solution to Problem

According to a certain embodiment, a system for detecting a target approaching a movable body is provided. The system includes: an imaging device provided at a movable body; a range setting section that sets a detection range for a target on an image acquired from the imaging device; a posture detection section that detects a change in a posture of the imaging device or the movable body; an entry detection section that detects entry of the target into the detection range; and an output section that outputs the image and the detection range, The range setting section changes the detection range on the image based on the change in the posture of the imaging device or the movable body.

In a certain aspect, the imaging device is an omnidirectional camera, and the imaging device is provided at the movable body such that a center of a lens is directed vertically downward with respect to a traveling direction of the movable body.

In a certain aspect, the image includes one or more regions surrounding the movable body.

In a certain aspect, the imaging device is connected to the movable body via a stabilizer that suppresses a shake of the imaging device.

In a certain aspect, the detection range includes a first detection range and a second detection range. The second detection range is close to the movable body with respect to the first detection range, and the entry detection section sets different alert levels for the first detection range and the second detection range respectively. The output section outputs a first alert based on entry of the target into the first detection range, and the output section outputs a second alert different from the first alert based on entry of the target into the second detection range.

In a certain aspect, the range setting section masks a range in which the movable body is captured on the image, and the masked range is excluded from the detection range.

In a certain aspect, the output section outputs information indicating a position and/or a direction of the target based on the entry of the target into the detection range.

Further, according to another embodiment, a device for detecting a target approaching a movable body is provided. The device includes: a range setting section that sets a detection range for a target on an image acquired from an imaging device provided at a movable body; a posture detection section that detects a change in a posture of the imaging device or the movable body; an entry detection section that detects entry of the target into the detection range; and an output section that outputs the image and the detection range, wherein the range setting section changes the detection range on the image based on the change in the posture of the imaging device or the movable body.

Further, according to another embodiment, a computer-executable method for detecting a target approaching a movable body is provided. The method includes: setting a detection range for a target on an image acquired from an imaging device provided at a movable body; detecting a change in a posture of the imaging device or the movable body; detecting entry of the target into the detection range; outputting the image and the detection range; and changing the detection range on the image based on the change in the posture of the imaging device or the movable body.

Furthermore, a computer-executable program for detecting a target approaching a movable body is provided. The program causes a computer to perform: setting a detection range for a target on an image acquired from an imaging device provided at a movable body; detecting a change in a posture of the imaging device or the movable body; detecting entry of the target into the detection range; outputting the image and the detection range; and changing the detection range on the image based on the change in the posture of the imaging device or the movable body.

### Advantageous Effects of Invention

According to a certain embodiment, even when the posture of the movable body is changed, it is possible to detect entry of a target within a certain range from the movable body as a detection range.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram illustrating an application example of a technique of the present disclosure.

FIG. 2 is a diagram illustrating an example of a configuration of a system 200 according to the present embodiment.

FIG. 3 is a diagram illustrating an example of a hardware configuration of a server 210.

FIG. 4 is a diagram illustrating an example of a relation between a video and an incident angle of light in a fish-eye lens camera.

FIG. 5 is a diagram illustrating an example of a manner of adjusting a detection range in response to a change in a posture of a movable body 100 or a camera 110.

FIG. 6 is a diagram illustrating an example of a method of calculating a distance of moving a central point of a detection range 120.

FIG. 7 is a diagram illustrating an example of a method of calculating the distance and direction of moving the central point of the detection range 120 using a value of an output signal of an acceleration sensor.

FIG. 8 is a diagram illustrating a first example of the detection range.

FIG. 9 is a diagram illustrating a second example of the detection range.

FIG. 10 is a diagram illustrating a third example of the detection range.

FIG. 11 is a diagram illustrating a fourth example of the detection range.

FIG. 12 is a diagram illustrating a first example of an alert.

FIG. 13 is a diagram illustrating a second example of the alert.

FIG. 14 is a diagram illustrating a third example of the alert.

FIG. 15 is a diagram illustrating an example of a procedure of internal processing of the system 200.

### DETAILED DESCRIPTION OF EMBODIMENTS

Hereinafter, embodiments of the technical idea according to the present disclosure will be described with reference to figures. In the following description, the same components are denoted by the same reference characters. Their names and functions are the same. Therefore, detailed description thereof will not be repeated.

### A. Application Example

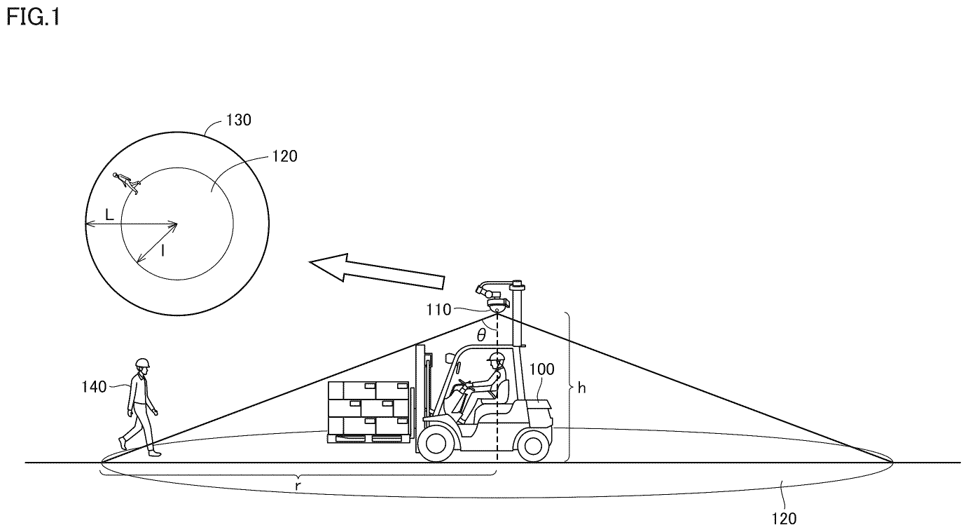

FIG. 1 is a diagram illustrating an application example of a technique of the present disclosure. With reference to FIG. 1, an example of a movable body to which the technique of the present disclosure is applicable, a problem that may occur at the time of safety confirmation around the movable body, and terms used in the present specification will be described.

### a. Example of Use of Technique of the Present Disclosure

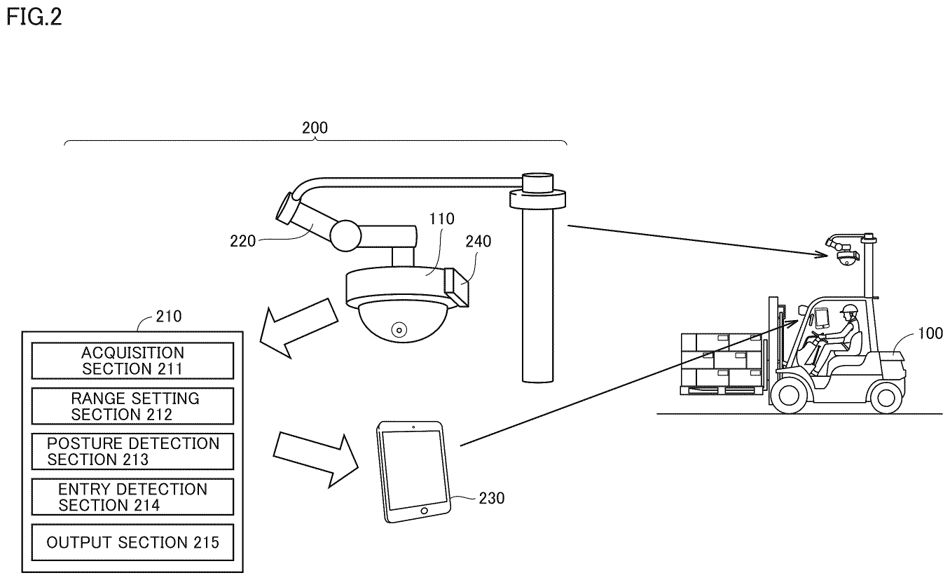

As an example, the technique of the present disclosure is provided as a system 200 (see FIG. 2). The system 200 is applicable to any movable body 100 such as a forklift. More specifically, the system 200 can analyze a video from a fish-eye lens camera (hereinafter referred to as the “camera 110”) provided at the movable body so as to detect whether or not a target 140 has entered a certain range from the movable body 100. The camera 110 can be installed at any location of the movable body 100 as long as the surroundings of the movable body 100 can be captured. In the example of FIG. 1, the camera 110 is attached to the movable body 100 via a pole.

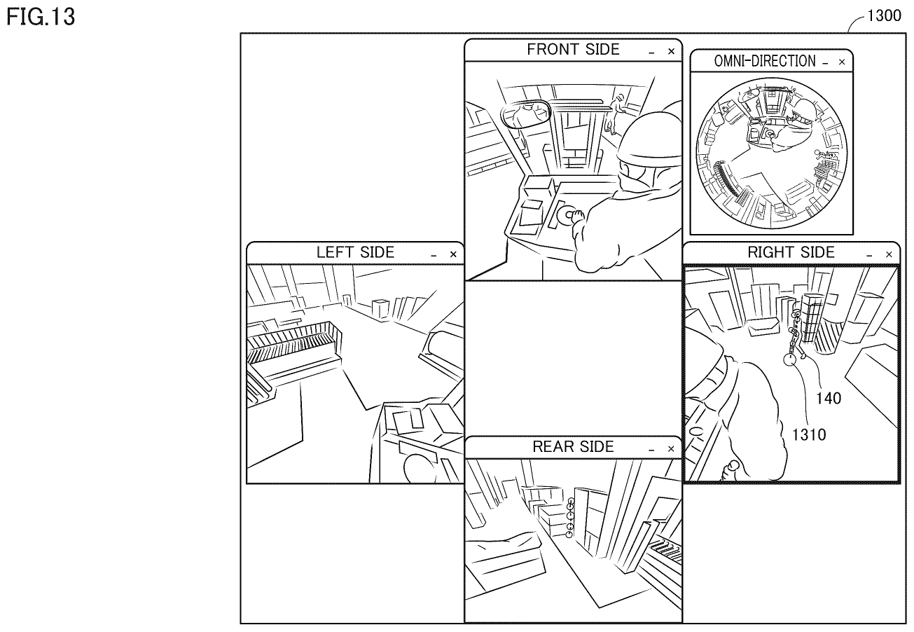

The system 200 acquires and analyzes an image 130 from the camera 110. According to a certain embodiment, the system 200 can acquire and analyze a video from the camera 110. Furthermore, the image 130 acquired from the camera 110 may be one frame of a video. Hereinafter, it is assumed that the system 200 analyzes the image 130, but the system 200 may analyze a video instead of the image 130. The image 130 analyzed by the system 200 may be one frame of a video. In this case, the system 200 may analyze the video by continuously analyzing images 130. According to a certain embodiment, the image 130 includes one or more regions surrounding the movable body as illustrated in FIG. 13. As an example, the image 130 may be one fish-eye image. As another example, the image 130 may be four planar images generated from one fish-eye image. The four planar images are front, rear, left, and right images with respect to the movable body 100. Further, as another example, the image 130 may be two or more images captured by a plurality of lenses. Furthermore, according to another embodiment, the system 200 may analyze the image by using an AI technique or a machine learning technique.

The camera 110, which is a fish-eye lens camera, can capture an image far away with the movable body 100 being centered. In the example of FIG. 1, a distance from the movable body 100 to an end of the image 130 is a radius L. Actually, the camera 110 can capture an image far beyond the horizon. Therefore, the radius L indicates the distance from the movable body 100 to the end of the image 130 in an image presented on a display.

The system 200 analyzes the image 130 and sets, as a detection range 120 for the target 140, a region within a radius l from the movable body. The radius l is a radius presented on the display. The radius l corresponds to a radius r of an actual detection range. The system 200 determines the detection range 120 based on a height h of the camera 110 from the ground and an angle θ of incident light. The radius r indicates a radius of the detection range 120 when the camera 110 is centered. Further, the incident light at the angle θ is incident light from the outer periphery of the detection range 120 (circle with the radius r).

The system 200 analyzes the image 130 and determines whether or not the target 140 has entered the detection range 120. The system 200 transmits an analysis result for the image 130 to a terminal 230 (see FIG. 2). The analysis result for the image 130 includes the image 130, the detection range 120, and information indicating whether or not the target 140 has entered the detection range 120.

An operator can check whether or not the target 140 has entered the detection range 120 by making reference to the analysis result for the image 130 presented on a display of the terminal 230. According to a certain embodiment, an alert may be output from the terminal 230 based on the entry of the target 140 into the detection range 120. The alert may be presented on the display. Further, the alert may be output by a buzzer sound, a voice, or the like. Furthermore, the alert may include both the presentation on the display and the buzzer sound, the voice, or the like.

According to a certain embodiment, the terminal 230 may be installed at the movable body 100. In this case, the operator can check the display of the terminal 230 while riding on the movable body 100 and operating the movable body 100. According to another embodiment, the terminal 230 may be installed at a position away from the movable body 100. In this case, the operator can check the display of the terminal 230 while remotely operating the movable body 100. Furthermore, according to another embodiment, a person who operates the movable body 100 may be different from a person who monitors the display of the terminal 230. In this case, the terminal 230 can be installed at a position away from the movable body 100.

### b. Problem That May Occur at Time of Safety Confirmation Around Movable Body

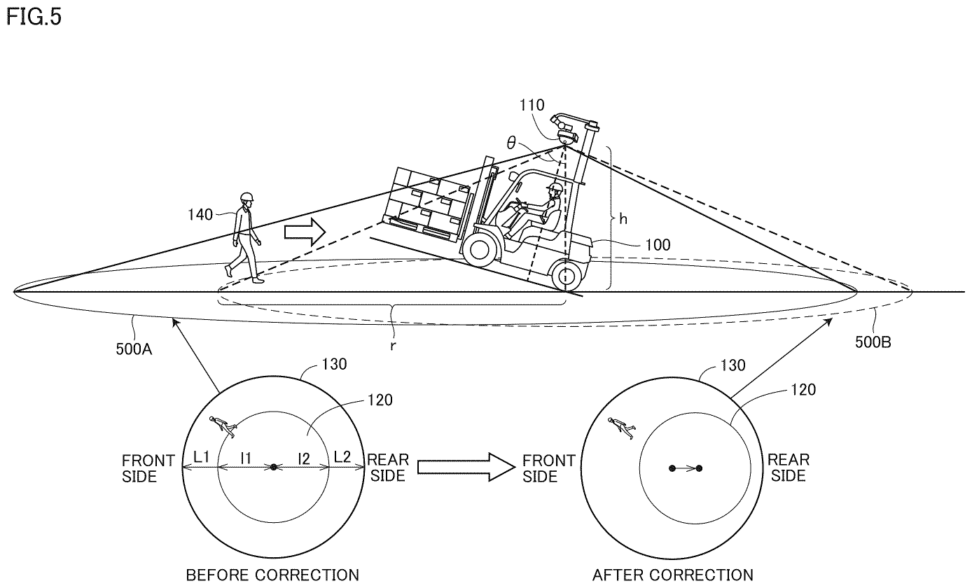

As described above, the system 200 can analyze the image 130 acquired from the camera 110 so as to detect the target 140 having approached the movable body 100 by a certain distance or more, In other words, the system 200 can detect the target 140 having entered the detection range 120. However, when the movable body 100 or the camera 110 is inclined, the target 140 having approached the movable body 100 by the certain distance or more cannot be detected. For example, it is assumed that the movable body 100 is climbing up a slope as illustrated in FIG. 5. In this case, the camera 110 is inclined on the front side of the movable body 100, and thus can capture an image in a long distance on the front side of the movable body 100. Conversely, the camera 110 can only capture an image in a short distance on the rear side of the movable body 100. As a result, the radius L1 on the front side of the movable body 100 and the radius L2 on the rear side of the movable body 100 in the image 130 become different. The radius L1 indicates a longer distance than the radius L2.

In this case, it is assumed that the system 200 determines the detection range 120 using the method described with reference to FIG. 1. On this occasion, a radius l1 on the front side of the movable body 100 and a radius l2 on the rear side of the movable body 100 are also different. The radius l1 indicates a longer distance than the radius l2. In such a state in which the movable body 100 or the camera 110 is inclined, the detection range 120 does not necessarily indicate a region within the certain distance from the movable body 100.

Therefore, when the movable body 100 or the camera 110 is inclined, the system 200 corrects the detection range 120. Thus, the system 200 keeps the detection range 120 indicating the region within the certain range from the movable body 100.

### c. Terms Used in Present Specification

Next, terms used in the present specification will be described.

In the present specification, the “system” includes a configuration constituted of one or a plurality of devices, and a server. When the system is constituted of one device, the system may be read as the device. Furthermore, the system includes a virtual machine or a container built in a cloud environment, or a configuration constituted of at least a part of these. Furthermore, the device may be any information processing device such as a personal computer, a workstation, a server device, a tablet, or a smartphone. The device may also be a combination of these.

According to a certain embodiment, the system may be connected to input/output devices such as a display and a keyboard, and may be used by a user. According to another embodiment, the system may provide various functions to the user as a service or a web application via a network. In this case, the user can use the functions of the system via a browser or client software installed on the user's terminal.

In the present specification, the “movable body” includes any object including any moving means such as wheels, caterpillar tracks, feet, magnetic force, or pneumatic pressure. Further, the movable body may be an unmanned machine or a manned machine. For example, the movable body includes a forklift, an AGV (Automated Guided Vehicle), an automobile, and a heavy machine. Moreover, the movable body can include a drone or the like that moves at a low altitude.

In the present specification, the “target” is a target to be monitored by the system 200. The target may include a movable object and/or a stationary object. Moreover, the object may include a living object and a non-living object. As an example, the target may include a person, an AMR, an AGV, or any movable body operated by a person. For example, for the system 200 provided in the movable body, each of the person, the AMR, and the AGV around the movable body can be the target. Moreover, for the system 200 provided in the movable body, another movable body around the movable body may also be a target. According to a certain embodiment, an object to be the target can be input to system 200 in advance. For example, it is assumed that each of the person and the AMR is input to the system 200 as the target. In this case, the system 200 outputs an alert when each of the person and the AMR enters the detection range 120. In this way, the user of the system 200 can set the target in the system 200 in advance.

In the present specification, the “camera” used by the system 200 is the camera 110 for capturing an image of the surroundings of the movable body 100. Moreover, an omnidirectional camera includes one fish-eye lens camera, a camera in which two fish-eye lens cameras are combined, and a camera in which any one or more lenses are combined. According to a certain embodiment, the camera 110 may be one fish-eye lens camera. According to another embodiment, the camera 110 may be an omnidirectional camera in which two fish-eye lens cameras are bonded together. Moreover, according to another embodiment, the camera 110 may be another camera in which a plurality of lenses are combined. In this case, the camera 110 or a server 210 (see FIG. 2) can generate one image by joining a plurality of images captured via the respective lenses. In the example illustrated in the present specification, the camera 110 is one fish-eye lens camera, but an implementation example of the camera 110 is not limited thereto. According to a certain embodiment, the camera 110 may be a camera in which a plurality of lenses are combined.

In the present specification, the “alert” output by the system 200 includes any output for notifying that the target 140 has entered the detection range 120. Moreover, the alert includes any output form for indicating an entry position or entry direction of the target 140 in the detection range 120. As an example, the alert includes any output form such as a buzzer sound or voice, a mark of the target 140 presented on the screen, an arrow, a point, a numerical value of a distance, and blinking of a part of the screen.

### b. System Configuration

FIG. 2 is a diagram illustrating an example of a configuration of the system 200 according to the present embodiment. The system 200 includes the camera 110, the server 210, a stabilizer 220, the terminal 230, and an acceleration sensor 240. The acceleration sensor 240 is built in or connected to the camera 110. Alternatively, the acceleration sensor 240 may be provided at a position away from the camera 110 (any position inside or outside a vehicle body of the movable body 100). In this case, the acceleration sensor 240 detects inclination of the vehicle body of the movable body 100. According to a certain embodiment, the system 200 may include the camera 110, the server 210, and the acceleration sensor 240, and may not include the stabilizer 220 and the terminal 230. According to another embodiment, the system 200 may include the server 210 and may not include the camera 110, the stabilizer 220, the terminal 230, and the acceleration sensor 240.

The camera 110 is a camera (imaging device) provided at the movable body 100. The camera 110 captures an image of the movable body 100 and its surroundings. In the example of FIG. 2, the system 200 includes a fish-eye lens camera (camera 110) having an angle of view of 180 degrees. From the installation position of the camera 110, the camera 110 can downwardly capture a 360-degree image of the front, rear, left, and right sides. The imaging device (camera 110) is provided at the movable body 100 such that the center of the lens is directed vertically downward with respect to the traveling direction of the movable body 100. The camera 110 transmits the captured image to the server 210. Further, the camera 110 acquires a value of an output signal of the acceleration sensor 240 and transmits the value of the output signal of the acceleration sensor 240 to the server 210. The value of the output signal of the acceleration sensor includes values of accelerations in x-axis, y-axis, and z-axis directions as viewed from the acceleration sensor. According to a certain embodiment, the angle of view of the camera 110 may be an angle other than 180 degrees. According to another embodiment, the camera 110 may be an omnidirectional camera in which two fish-eye lens cameras are bonded together to face the front and rear sides. In this case, the camera 110 can be provided at the movable body 100 such that an image of the surroundings of the movable body 100 can be captured by the two fish-eye lens cameras.

According to a certain embodiment, the camera 110 is a fish-eye lens camera. According to another embodiment, the camera 110 is a camera in which a plurality of lenses are combined. When the camera 110 is a camera in which a plurality of lenses are combined, the camera 110 may capture an image of only the surroundings of the movable body 100. When the camera 110 is a fish-eye lens camera, the center of the lens of the camera 110 is directed vertically downward with respect to the traveling direction of the movable body 100. According to a certain embodiment, the center of the lens of the camera 110 can be set to be directed vertically downward (direction in which gravitational acceleration occurs) with respect to the horizon.

The server 210 analyzes the image 130 acquired from the camera 110 and outputs an analysis result for the image 130 to the terminal 230. The server 210 includes an acquisition section 211, a range setting section 212, a posture detection section 213, an entry detection section 214, and an output section 215.

The acquisition section 211 acquires, from the camera 110, the image 130 captured by the camera 110. According to a certain embodiment, the acquisition section 211 may acquire, from the camera 110, a video captured by the camera 110. The acquisition section 211 outputs the acquired image 130 to the range setting section 212. Furthermore, the acquisition section 211 acquires the value of the output signal of the acceleration sensor 240 from the camera 110. The acquisition section 211 outputs the acquired value of the output signal of the acceleration sensor 240 to the posture detection section 213.

The range setting section 212 sets the detection range 120 in the image 130. According to a certain embodiment, based on input of the radius l from the user, the range setting section 212 may set the detection range 120 to have the radius l. For example, the user can determine the radius l by touching a part of the screen 130 on the display of the terminal 230. According to another embodiment, the radius l of the detection range 120 may be determined in advance. In this case, the system 10, 20 can read information of the radius l stored in a secondary storage device 3 into a primary storage device 2, and can make reference thereto. According to another embodiment, the range setting section 212 may calculate the radius l based on reception of input of the radius r from the user. More specifically, the range setting section 212 determines the detection range 120 (radius l) based on the height h of the camera 110 from the ground and the angle θ of the incident light to the fish-eye lens from the ground with the radius r. The height h of the camera 110 from the ground may be set in the server 210 in advance. The range setting section 212 outputs the image 130 and the detection range 120 to the entry detection section 214.

The posture detection section 213 compares the value of the output signal of the acceleration sensor 240 as acquired this time with the value of the output signal of the acceleration sensor 240 as acquired the previous time. Next, the posture detection section 213 finds a difference between the value of the output signal of the acceleration sensor 240 as acquired this time and the value of the output signal of the acceleration sensor 240 as acquired the previous time. According to a certain embodiment, the posture detection section 213 may compare the value of the output signal of the acceleration sensor 240 as acquired this time with a reference value. In this case, the posture detection section 213 finds a difference between the value of the output signal of the acceleration sensor 240 as acquired this time and the reference value. The reference value is obtained by calibration of the acceleration sensor. The reference value is, for example, an acceleration when the movable body 100 is in a stationary state on a horizontal floor. The posture detection section 213 detects a change in a posture of the movable body 100 or the camera 110 based on the difference. The posture detection section 213 calculates, from the values of accelerations in the x-axis, y-axis, and z-axis directions of the acceleration sensor 240, a direction of moving the central position of the detection range 120 and a distance of moving the detection range 120. The posture detection section 213 outputs, to the range setting section 212, the direction of moving the central position of the detection range 120 and the distance of moving the detection range 120.

The range setting section 212 corrects the detection range 120 based on the acquired direction of moving the central position of the detection range 120 and the acquired distance of moving the detection range 120. More specifically, the range setting section 212 moves the detection range 120 in the image 130. According to a certain embodiment, the range setting section 212 may acquire the values of accelerations from the posture detection section 213. In this case, the range setting section 212 calculates, from the values of accelerations, the direction of moving the central position of the detection range 120 and the distance of moving the detection range 120. Next, the range setting section 212 corrects the detection range 120 based on the calculated direction of moving the central position of the detection range 120 and the calculated distance of moving the detection range 120. Whenever the detection range 120 is updated, the range setting section 212 newly outputs the image 130 and the detection range 120 to the entry detection section 214.

The entry detection section 214 analyzes the image 130 using a known image recognition technique or the like so as to detect that the target 140 has entered the detection range 120. The entry detection section 214 outputs the image 130, the detection range 120, and the analysis result to the output section 215. The analysis result may include occurrence or non-occurrence of entry of the target 140 into the detection range 120. Further, the analysis result may also include part or all of information such as attribute information of the target 140 (information as to whether the target is a person, a vehicle, or the like), the entry position of the target 140, the entry direction of the target 140, and the distance of the target 140 to the movable body 100. According to a certain embodiment, the entry detection section 214 may analyze the image 130 by using an AI technique or a machine learning technique.

When the target 140 enters the detection range 120, the output section 215 transmits the image 130, the detection range 120, and the alert to the terminal 230. When the target 140 does not enter the detection range 120, the output section 215 transmits the image 130 and the detection range 120 to the terminal 230.

The stabilizer 220 prevents the camera 110 from changing its posture abruptly. That is, the stabilizer 220 suppresses a shake of the camera 110. The stabilizer 220 gently adjusts the orientation of the camera 110 such that the camera 110 is directed vertically downward with respect to the traveling direction of the movable body 100. According to a certain embodiment, the stabilizer 220 may gently adjust the orientation of the camera 110 such that the camera 110 is directed vertically downward with respect to the horizon. The imaging device (camera 110) is connected to the movable body 100 via the stabilizer 220 that suppresses the shake of the imaging device (camera 110).

The terminal 230 outputs the image 130, the detection range 120, and the alert to the display. According to a certain embodiment, the alert may be a mark for the target 140 having entered the detection range 120. According to another embodiment, the alert may be information indicating the entry direction of the target 140, the entry position of the target 140, or the distance of the target 140 to the movable body 100. Furthermore, according to another embodiment, the alert may be a presentation for blinking part or whole of the screen. According to another embodiment, the alert may be a buzzer sound, a voice, or the like. Further, according to another embodiment, the alert may be any combination of these output forms.

According to a certain embodiment, the terminal 230 may include a function of the server 210. In this case, communication between the camera 110 and the server 210 can be read as communication between the camera 110 and the terminal 230. Furthermore, the processing of the server 210 can be read as the processing of the terminal 230. Furthermore, according to another embodiment, the camera 110 may include the function of the server 210. In this case, communication between the server 210 and the terminal 230 can be read as communication between the camera 110 and the terminal 230. Furthermore, the processing of the server 210 can be read as the processing of the camera 110. When the camera 110 or the terminal 230 includes the function of the server 210, the system 200 may not include the server 210.

As described with reference to FIG. 2, the system 200 includes: the imaging device (camera 110) provided at the movable body 100; the range setting section 212 that sets the detection range 120 for the target on the image 130 acquired from the camera 110; the posture detection section 213 that detects the change in the posture of the imaging device or the movable body 100; the entry detection section 214 that detects the entry of the target to the detection range 120; and the output section 215 that outputs the image 130 and the detection range 120. Moreover, the range setting section 212 changes the detection range 120 on the image 130 based on the change in the posture of the imaging device or the movable body 100.

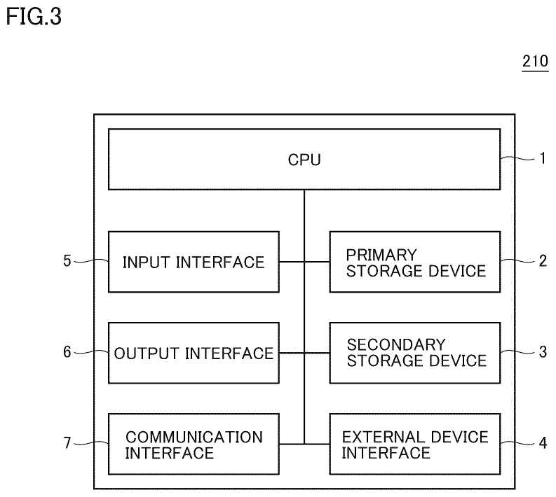

FIG. 3 is a diagram illustrating an example of a hardware configuration of the server 210. According to a certain embodiment, the terminal 230 may also include the hardware configuration illustrated in FIG. 3. The server 210 includes a CPU (Central Processing Unit) 1, the primary storage device 2, the secondary storage device 3, an external device interface 4, an input interface 5, an output interface 6, and a communication interface 7.

The CPU 1 can execute programs for implementing various functions of the server 210. The CPU 1 is constituted of, for example, at least one integrated circuit. According to a certain embodiment, the server 210 may include, for example, at least one CPU, at least one GPU (Graphics Processing Unit), at least one FPGA (Field Programmable Gate Array), at least one ASIC (Application Specific Integrated Circuit), or a combination thereof.

The primary storage device 2 stores a program to be executed by the CPU 1 and data to be referred to by the CPU 1. According to a certain embodiment, the primary storage device 2 can be implemented by a DRAM (Dynamic Random Access Memory), an SRAM (Static Random Access Memory) or the like.

The secondary storage device 3 is a nonvolatile memory, and stores a program to be executed by the CPU 1 and data to be referred to by the CPU 1. In such a case, the CPU 1 executes the program read from the secondary storage device 3 to the primary storage device 2 and refers to the data read from the secondary storage device 3 to the primary storage device 2. According to a certain embodiment, the secondary storage device 3 may be implemented by an HDD (Hard Disk Drive), an SSD (Solid State Drive), an EPROM (Erasable Programmable Read Only Memory), an EEPROM (Electrically Erasable Programmable Read Only Memory), a flash memory, or the like.

The external device interface 4 can be connected to any external device such as a printer, a scanner, and an external HDD. According to a certain embodiment, the external device interface 4 can be implemented by a USB (Universal Serial Bus) terminal or the like.

The input interface 5 can be connected to any input device such as a keyboard, a mouse, a touch pad or a game pad. According to a certain embodiment, the input interface 5 can be implemented by a USB terminal, a PS/2 terminal, a Bluetooth (registered trademark) module, and the like. According to another embodiment, the input interface 5 may be any input device itself, such as a keyboard, a mouse, a touch pad, or a game pad.

The output interface 6 can be connected to any output device such as a cathode-ray tube display, a liquid crystal display, or an organic EL (Electro-Luminescence) display. According to a certain embodiment, the output interface 6 can be implemented by a USB terminal, a D-sub terminal, a DVI (Digital Visual Interface) terminal, an HDMI (registered trademark) (High-Definition Multimedia Interface) terminal, a display port terminal, and the like. According to another embodiment, the output interface 6 may be any output device itself such as a display.

The communication interface 7 is connected to another device via a wired network or a wireless network. According to a certain embodiment, the communication interface 7 can be implemented by a wired LAN (Local Area Network) port, a Wi-Fi (registered trademark) (Wireless Fidelity) module, and the like. According to another embodiment, the communication interface 7 can transmit and receive data using a communication protocol such as TCP/IP (Transmission Control Protocol/Internet Protocol) or UDP (User Datagram Protocol).

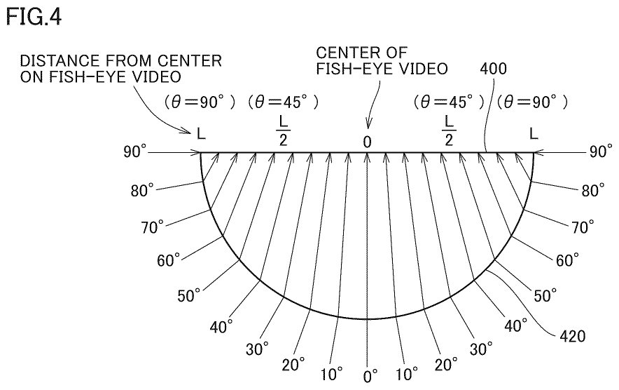

FIG. 4 is a diagram illustrating an example of a relation between a video and an incident angle of light in the fish-eye lens camera. In the example of FIG. 4, the camera 110 will be described as a camera having an angle of view of 180 degrees, but the application example of the technique of the present disclosure is not limited thereto. The camera 110 may have any angle of view (for example, the angle of view may be 185 degrees). A video 400 is in the form of a circle and corresponds to the image 130. External light is refracted through the fish-eye lens 420 and then heads toward a video sensor. The incident angle of the light to the fish-eye lens 420 and a projection position of the light in the video 400 have a correspondence. For example, light having an incident angle of 0 degree to the fish-eye lens 420 is projected at the center of the video 400. As another example, light having an incident angle of about 45 degrees to the fish-eye lens 420 is projected to a position at a distance L/2 from the center of the video 400. As still another example, light having an incident angle of 90 degrees to the fish-eye lens 420 is projected to a position at a distance L from the center of the video.

By calculating a distance of any point in the image 130 from the center of the image 130, the system 200 can find a corresponding incident angle. For example, it is assumed that the system 200 determines an incident angle of light at a location at which the target 140 is captured in the image 130. In this case, the system 200 can calculate a distance from the movable body 100 to the target 140 based on the incident angle and the height h of the camera 110 from the ground.

### C. Procedure of Adjusting Detection Range

FIG. 5 is a diagram illustrating an example of a manner of adjusting the detection range in response to the change in the posture of the movable body 100 or the camera 110. When the traveling direction of the movable body 100 is horizontal to the horizon, the camera 110 can capture an image that covers equal distances in all the directions with the movable body 100 being centered. However, when the posture of the movable body 100 or the camera 110 is changed, the obtained image is changed.

For example, it is assumed that the movable body 100 is climbing up a slope as illustrated in FIG. 5. In this case, the camera 110 is inclined on the front side of the movable body 100, and thus can capture an image in a long distance on the front side of the movable body 100. Conversely, the camera 110 can only capture an image in a short distance on the rear side of the movable body 100. As a result, the radius L1 on the front side of the movable body 100 and the radius L2 on the rear side of the movable body 100 in the image 130 become different. The radius L1 indicates a longer distance than the radius L2. That is, the image 130 is an inclined image. In this case, it is assumed that the system 200 determines the detection range 120 by using the method described with reference to FIG. 1. On this occasion, the radius l1 on the front side of the movable body 100 and the radius l2 on the rearward side of the movable body 100 are also different. The radius l1 indicates a longer distance than that of the radius l2. In such a state in which the movable body 100 or the camera 110 is inclined, the detection range 120 does not necessarily indicate the region within the certain distance from the movable body 100.

Therefore, when the movable body 100 or the camera 110 is inclined, the system 200 corrects the detection range 120. According to a certain embodiment, when the movable body 100 or the camera 110 is inclined, the system 200 moves the detection range 120 in the image 130 in accordance with the inclination. In this case, the system 200 moves the center of the detection range 120. According to another embodiment, when the movable body 100 or the camera 110 is inclined, the system 200 may change the shape of the detection range 120 in the image 130 in accordance with the inclination.

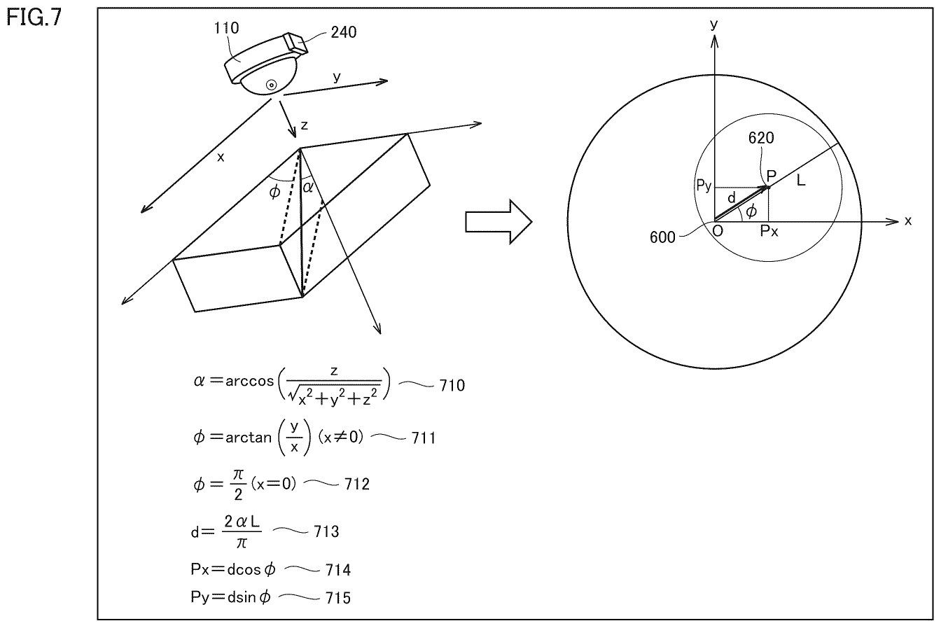

In the example of FIG. 5, the system 200 moves the detection range 120 in the image 130 rearward with respect to the movable body 100. A range 500A is an actual detection range corresponding to the detection range 120 before the correction in the image 130. A range 500B is an actual detection range corresponding to the detection range 120 after the correction in the image 130. The range 500A is long on the front side of the movable body 100 and is short on the rear side of the movable body. On the other hand, it is understood that the distances on the front and rear sides of the movable body 100 are the same in the range 500B. The system 200 uses formulas illustrated in FIG. 7 so as to calculate the coordinates of the destination to which the detection range 120 is moved in the image 130.

According to a certain embodiment, the stabilizer 220 may move the center of the lens of the camera 110 vertically downward with respect to the horizon when the posture of the movable body 100 is inclined. When the camera 110 is directed vertically downward with respect to the horizon, the detection range 120 does not needs to be shifted. However, the stabilizer 220 gently changes the posture of the camera 110. When the movable body 100 is inclined, the image 130 becomes an inclined image during a period of time until the camera 110 is directed vertically downward with respect to the horizon. Therefore, when the movable body 100 is inclined, the system 200 continues to shift the detection range 120 based on the posture of the movable body 100 until the camera 110 is directed vertically downward with respect to the horizon.

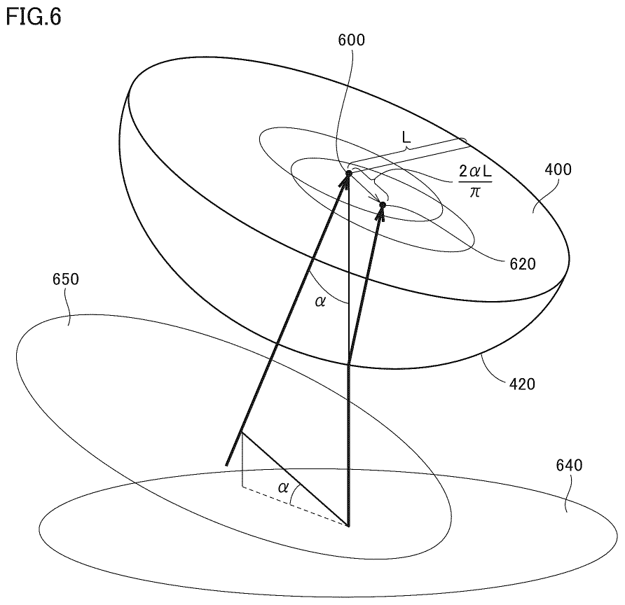

FIG. 6 is a diagram illustrating an example of a method of calculating the distance of moving the central point of the detection range 120. A plane 640 is a horizontal plane. A plane 650 is a plane that the movable body 100 faces. As can be seen from FIG. 6, the movable body is inclined by “α degrees” with respect to the horizontal plane (plane 640). In this case, the system 200 moves the central point 600 of the detection range 120 by a distance “2αL/π” based on the movable body 100 being inclined by the “α degrees”, A distance L indicates an imaging range of the camera 110. The distance L can be changed in response to scaling up/down the image 130 on the display. Moreover, the angle α is obtained from the value of the output signal of the acceleration sensor. In the example of FIG. 6, the destination to which the central point 600 is moved is a point 620.

FIG. 7 is a diagram illustrating an example of a method of calculating the distance and direction of moving the central point of the detection range 120 by using the value of the output signal of the acceleration sensor. A procedure for calculating the coordinates of the point 620 to which the central point 600 of the detection range 120 is moved will be described with reference to FIG. 7. The following description will be made on such an assumption that the acceleration sensor 240 is fixed to the camera 110, but this is merely an example. The acceleration sensor 240 may be fixed to the vehicle body of the movable body 100. Also in this case, the system 200 can calculate the inclination of the camera 110 based on the value of the output signal of the acceleration sensor 240 (the inclination of the vehicle body).

The system 200 performs calibration of the acceleration sensor 240 in advance. The system 200 performs calculations of the formulas illustrated in FIG. 7 by using, as reference values (initial values), the accelerations of the acceleration sensor 240 in the x, y, and z axes during the calibration. In the example of FIG. 7, the reference values of the respective axes (x, y, z) when a video at a center O of a fish-eye video (fish-eye image) coincides with a video incident in the gravity direction are defined as 0, 0, 1 g (g indicates the gravity acceleration). The system 200 may offset the values of x, y, and z in the formulas of FIG. 7 by the reference values (initial values) found by the calibration. The system 200 obtains an acceleration x in the x-axis direction, an acceleration y in the y-axis direction, and an acceleration z in the z-axis direction from the acceleration sensor 240. For example, the server 210 may acquire the value of the output signal of the acceleration sensor 240 via the camera 110. The server 210 may directly acquire the value of the output signal of the acceleration sensor 240 from the acceleration sensor 240. Next, the system 200 calculates an angle α of the current acceleration with respect to the z axis by using a formula 710. Next, the system calculates an angle φ of the current acceleration with respect to the x axis by using a formula 711 or a formula 712. When the acceleration x is not 0, the system 200 uses the formula 711. When the acceleration x is 0, the system 200 uses the formula 712. Next, the system 200 calculates a distance d of moving the central point of the detection range 120 by using a formula 713. Next, the system 200 calculates a distance Px of moving the central point of the detection range 120 in the x-axis direction by using a formula 714. Next, the system 200 calculates a distance Py of moving the central point of the detection range 120 in the y-axis direction by using a formula 715. Next, the system 200 moves the central point of the detection range 120 on the image 130 by the distance Px of moving in the x-axis direction and by the distance Py of moving in the y-axis direction. As a result, the central point 600 is moved to the point 620. The image 130 and the detection range 120 after the movement are presented on the screen of the terminal 230.

### D. Variations of Detection Range and Alert

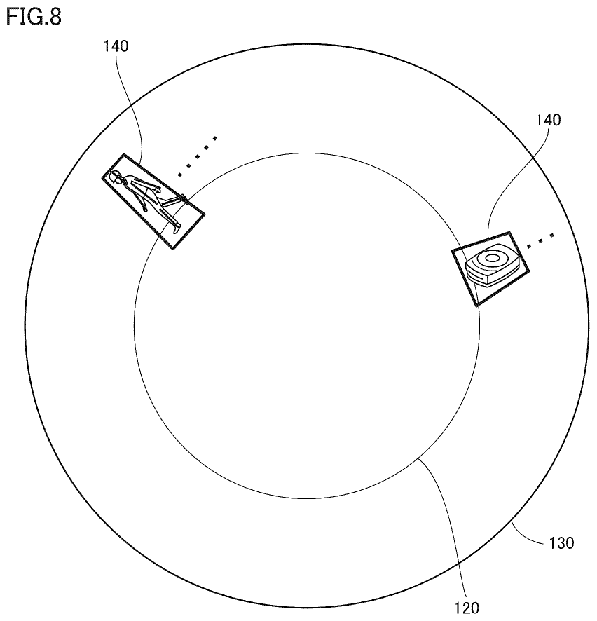

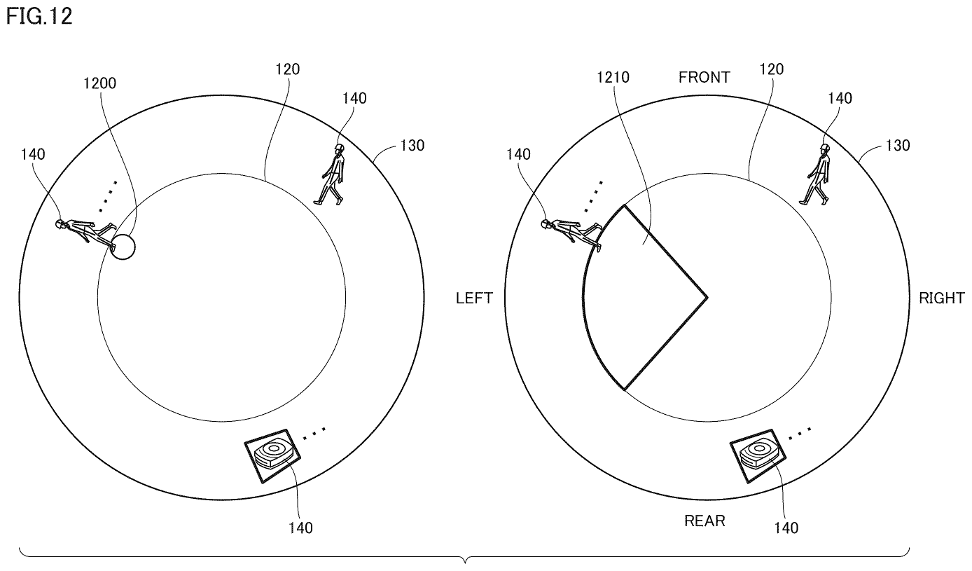

Next, variations of the detection range and the alert will be described with reference to FIGS. 8 to 11. The detection range and the alert illustrated in each of FIGS. 8 to 11 are presented on the display of the terminal 230. The system 200 may use the detection range illustrated in each of FIGS. 8 to 11 so as to determine whether or not the target 140 has entered the detection range 120. Furthermore, with reference to FIGS. 12 to 14, variations of the alert will be described. By the alert illustrated in each of FIGS. 12 to 14, the system 200 notifies the operator that the target 140 has entered the detection range 120. The system 200 may use any combination of the detection ranges illustrated in FIGS. 8 to 11 and the alerts illustrated in FIGS. 12 to 14.

FIG. 8 is a diagram illustrating a first example of the detection range. In the first example, the detection range 120 is represented by a circle with the movable body 100 being centered. When the movable body 100 is inclined, the system 200 moves the detection range 120 based on the procedure described with reference to FIG. 7.

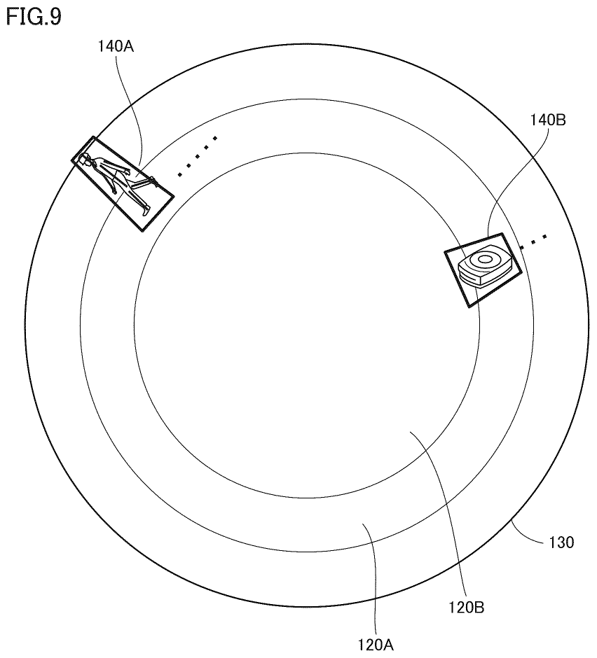

FIG. 9 is a diagram illustrating a second example of the detection range. In the second example, there are a plurality of detection ranges. In the example of FIG. 9, the system 200 sets a first detection range 120A and a second detection range 120B on the image 130. The central point of each of the first detection range 120A and the second detection range 120B is a certain position of the movable body 100. When the movable body 100 is inclined, the system 200 moves the first detection range 120A and the second detection range 120B based on the procedure described with reference to FIG. 7. The central points of the first detection range 120A and the second detection range 120B are the same. Therefore, destinations to which the first detection range 120A and the second detection range 120B are moved are the same.

The first detection range 120A is a range corresponding to a low-warning level, and the second detection range 120B is a range corresponding to a high-warning level. The second detection range 120B indicates a region close to the movable body 100 with respect to the first detection range 120A.

The system 200 outputs a first alert (low-warning alert) based on entry of a movable body into the first detection range 120A. Furthermore, the system 200 outputs a second alert (high-warning alert) based on entry of a movable body into the second detection range 120B. An output form of the first alert and an output form of the second alert may be different.

According to a certain embodiment, the system 200 may cause the output form of the second alert to be more noticeable than the output form of the first alert. For example, it is assumed that a target 140A enters the first detection range 120A and a target 140B enters the second detection range 120B. In this case, the system 200 may blink a mark for the target 140B more intensely than a mark for the target 140A.

That is, the detection range 120 may include the first detection range 120A and the second detection range 120B. Further, the second detection range 120B is close to the movable body with respect to the first detection range 120A. The entry detection section 214 sets different alert levels for the first detection range 120A and the second detection range 120B respectively. The output section 215 outputs the first alert based on the entry of the target into the first detection range 120A. Furthermore, the output section 215 outputs the second alert different from the first alert based on the entry of the target into the second detection range 120B.

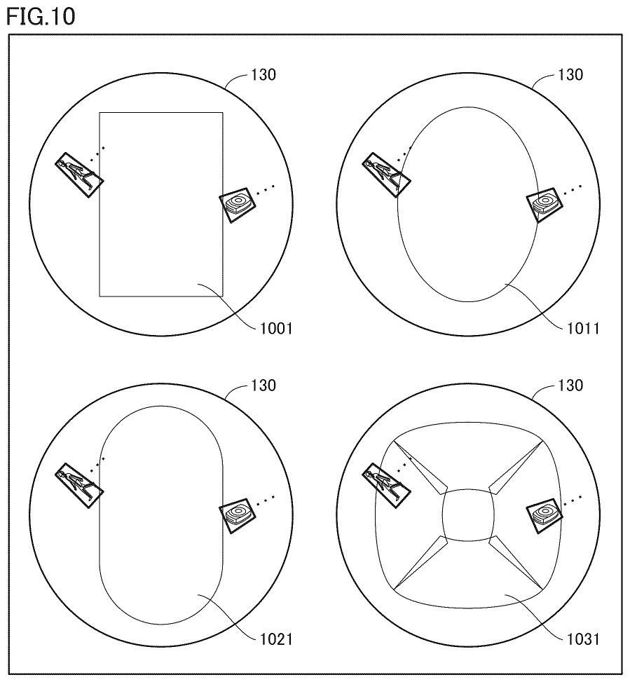

FIG. 10 is a diagram illustrating a third example of the detection range. The system 200 may form the detection range into any shape. As an example, the system 200 may use a detection range 1001 having a rectangular shape or a detection range 1011 having an elliptic shape. As another example, the system 200 may use a detection range 1021 that is a combination of a rectangle and semicircles, or a detection range 1031 that is divided into four. When the movable body 100 is inclined, the system 200 moves each of the detection ranges having these various shapes based on the procedure described with reference to FIG. 7.

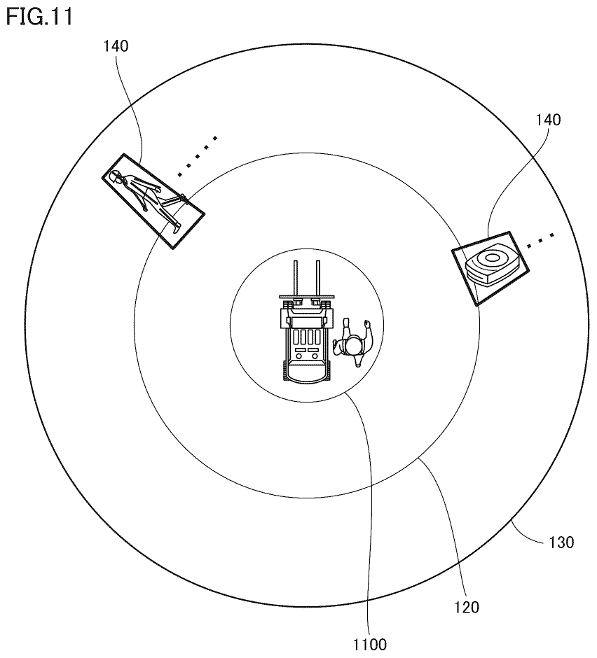

FIG. 11 is a diagram illustrating a fourth example of the detection range. The system 200 may mask a region in which the movable body 100 and/or the operator are/is present. The system 200 can exclude the masked region 1100 from the detection range 120. Thus, the system 200 can prevent the movable body 100 and/or the operator from being erroneously detected as the target 140. The system 200 can also perform the mask processing onto each of the detection ranges having the various shapes illustrated in FIG. 10. When the movable body 100 is inclined, the system 200 moves the detection range 120 based on the procedure described with reference to FIG. 7. On that occasion, the masked region 1100 may not be moved. That is, the range setting section 212 can mask the range in which the movable body 100 is captured on the image 130. In this case, the range setting section 212 excludes the masked range from the detection range 120.

FIG. 12 is a diagram illustrating a first example of the alert. As an example, the system 200 can mark, as the alert, the target 140 having entered the detection range 120. For example, the system 200 may apply a mark 1200 to the target 140 having entered the detection range 120. According to a certain embodiment, the mark 1200 may be superimposed on the target 140 or may be presented in the vicinity of the target 140. According to another embodiment, the mark 1200 may be a circle, a quadrangle, a triangle, or any other shape. Furthermore, according to another embodiment, the mark 1200 may be a frame that covers the target 140. Furthermore, according to another embodiment, the system 200 may change and/or blink the color of the target 140 having entered the detection range 120.

As another example, the system 200 may output, as the alert, a presentation 1210 for indicating the position and/or direction at and/or in which the target 140 has entered the detection range 120. In the example of FIG. 12, the presentation 1210 indicates that the target 140 has entered the left side of the detection range 120. According to a certain embodiment, the presentation 1210 may have any shape such as an arrow.

FIG. 13 is a diagram illustrating a second example of the alert. In the example of FIG. 13, the system 200 outputs a plurality of divided images (screen 1300) to the display of the terminal 230. These four images are front, rear, left, and right images with respect to the movable body 100. In this way, the system 200 can convert the fish-eye image (image 130) into the plurality of planar images, or the like. That is, the image 130 can include one or more regions (images) surrounding the movable body. The system 200 may then present the plurality of planar images on the display of the terminal 230 instead of the image 130. Furthermore, the system 200 can present the alert (mark 1310 or the like) on any of the plurality of planar images based on the entry of the target 140 into the detection range 120. The shape of the alert may be any shape.

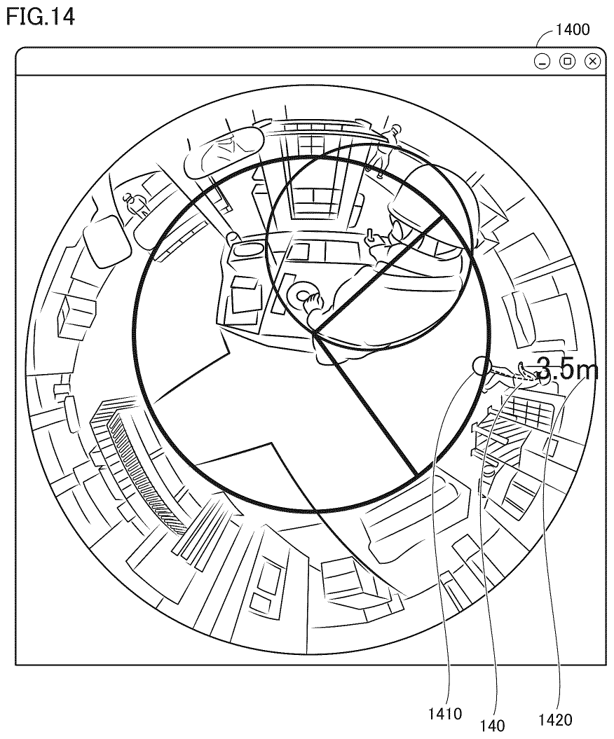

FIG. 14 is a diagram illustrating a third example of the alert. The system 200 can present, on the display of the terminal 230, a mark 1410 and a distance 1420 in the vicinity of the target 140 having entered the detection range 120 (screen 1400). The distance 1420 indicates a distance from the movable body 100 to the target 140. The operator can know the position of the target 140 by checking the mark 1410 and the distance 1420. The mark 1410 may be a mark such as the one illustrated in each of FIG. 12 and FIG. 13, or any other mark.

According to a certain embodiment, the system 200 can use the alert illustrated in each of FIGS. 12 to 14 in combination with any of the detection ranges illustrated in FIGS. 8 to 11. According to another embodiment, the system 200 can output the alert illustrated in each of FIGS. 12 to 14 to the display of the terminal 230 and can also output the alert by a buzzer sound, a voice, or the like.

### E. Flowchart

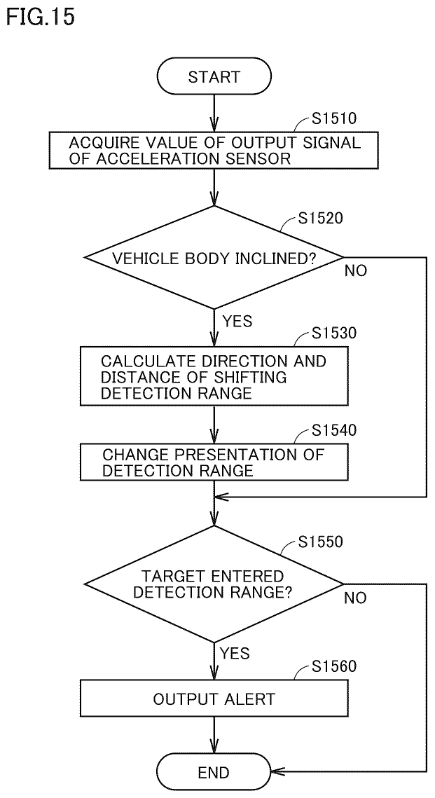

FIG. 15 is a diagram illustrating an example of an internal processing procedure of the system 200. According to a certain embodiment, the CPU 1 may load, from the secondary storage device 3 into the primary storage device 2, a program for performing the processing of FIG. 15, and execute the program. In another aspect, part or whole of the processing may be implemented as a combination of circuit elements configured to perform the processing. Furthermore, according to another embodiment, the server 210 may perform the whole of the processing illustrated in FIG. 15. Furthermore, according to another embodiment, the terminal 230 may perform the whole of the processing illustrated in FIG. 15. Further, according to another embodiment, the server 210 and the terminal 230 may perform the processing illustrated in FIG. 15 in cooperation with each other.

In a step S1510, the system 200 acquires the value of the output signal of the acceleration sensor 240. More specifically, the camera 110 acquires the output signal of the acceleration sensor. The server 210 receives the value of the output signal of the acceleration sensor 240 from the camera 110. According to a certain embodiment, the server 210 may directly receive, from the acceleration sensor 240, the value of the output signal of the acceleration sensor 240.

In a step S1520, the system 200 determines, based on the value of the output signal of the acceleration sensor 240, whether or not the vehicle body of the movable body 100 is inclined. The camera 110 is provided at the movable body 100. Therefore, it can be said that the system 200 determines, based on the value of the output signal of the acceleration sensor 240, whether or not the camera 110 is inclined. When it is determined that the vehicle body of the movable body 100 is inclined (YES in the step S1520), the system 200 transfers the control to a step S1530. Otherwise (NO in the step S1520), the system 200 transfers the control to a step S1550.

In the step S1530, the system 200 calculates direction and distance of shifting the detection range 120. The processing of this step corresponds to the calculations described with reference to FIGS. 6 and 7.

In a step S1540, the system 200 changes the presentation of the detection range 120. More specifically, the system 200 moves the detection range 120 based on the direction and distance calculated in the step S1530. According to a certain embodiment, the system 200 may change the shape of the detection range 120 based on the direction and distance calculated in the step S1530. According to another embodiment, the server 210 may transmit information of the direction and distance to the terminal 230 whenever the inclination of the vehicle body of the movable body 100 is detected. In this case, the terminal 230 moves the detection range 120 in the image 130 presented on the display, based on the received information of the direction and distance.

In the step S1550, the system 200 determines whether or not the target 140 has entered the detection range 120. The system 200 can use a known image recognition technique to determine whether or not the target 140 has entered the detection range 120. Moreover, the system 200 can mask a region in which the movable body 100 and the operator are present and can exclude the masked region from the detection range 120. When it is determined that the target 140 has entered the detection range 120 (YES in the step S1550), the system 200 transfers the control to a step S1560. Otherwise (NO in the step S1550), the system ends the processing.

In the step S1560, the system 200 outputs the alert. More specifically, the terminal 230 outputs the alert on the display as illustrated in each of FIGS. 12 to 14. The server 210 transmits, to the terminal 230, an alert output instruction and information necessary to output the alert. The information necessary to output the alert can include information of the position of the target 140 having entered the detection range 120. Moreover, the information necessary to output the alert can also include information of a distance from the movable body 100 to the target 140 having entered the detection range 120. The terminal 230 can output the alert to the display based on the received alert output instruction and the information necessary to output the alert. According to a certain embodiment, in addition to outputting the alert to the display, the terminal 230 may output the alert by a buzzer sound, a voice, or the like,

As described above, the system 200 according to the present embodiment can acquire the image 130 of the surroundings of the movable body 100 and can set the detection range 120 in the image 130. Further, the system 200 can detect the inclination of the movable body 100 and calculate, from the inclination, the direction and distance of shifting the detection range 120. The system 200 updates (shifts) the detection range 120 in the image 130 based on the calculated direction and distance. Thus, the system 200 can determine whether or not the target 140 has entered by a certain distance or less from the movable body 100 regardless of the posture of the movable body 100.

The embodiments disclosed herein are illustrative and non-restrictive in any respect. The scope of the present disclosure is defined by the terms of the claims, rather than the embodiments described above, and is intended to include any modifications within the scope and meaning equivalent to the terms of the claims. Moreover, the contents of disclosure as described in the embodiments and the modification examples are intended to be implemented solely or in combination as much as possible.

### REFERENCE SIGNS LIST

1 CPU; 2 primary storage device; 3 secondary storage device; 4 external device interface; 5 input interface; 6 output interface; 7 communication interface; 100 movable body; 110 camera; 120, 1001, 1011, 1021, 1031 detection range; 120A first detection range; 120B second detection range; 130 image; 140, 140A, 140B target; 200 system; 210 server; 211 acquisition section; 212 range setting section; 213 posture detection section; 214 entry detection section; 215 output section; 220 stabilizer; 230 terminal; 240 acceleration sensor; 400 video; 420 fish-eye lens; 500A 500B range; 600 central point; 620 point; 640, 650 plane; 1100 region; 1200, 1310, 1410 mark; 1210 presentation; 1300, 1400 screen.

1. A system comprising:
an imaging device provided at a movable body;
a processor that is configured to:
set a detection range for a target on an image acquired from the imaging device;
detect a change in a posture of the imaging device or the movable body;
detect entry of the target into the detection range; and
output the image and the detection range, wherein
the processor changes the detection range on the image based on the change in the posture of the imaging device or the movable body.

2. The system according to claim 1, wherein
the imaging device is an omnidirectional camera, and
the imaging device is provided at the movable body such that a center of a lens is directed vertically downward with respect to a traveling direction of the movable body.

3. The system according to claim 1, wherein the image includes one or more regions surrounding the movable body.

4. The system according to claim 1, wherein the imaging device is connected to the movable body via a stabilizer that suppresses a shake of the imaging device.

5. The system according to claim 1, wherein
the detection range includes a first detection range and a second detection range,
the second detection range is close to the movable body with respect to the first detection range,
the processor sets different alert levels for the first detection range and the second detection range respectively,
the processor outputs a first alert based on entry of the target into the first detection range, and
the processor outputs a second alert different from the first alert based on entry of the target into the second detection range.

6. The system according to claim 1, wherein
the processor masks a range in which the movable body is captured on the image, and
the masked range is excluded from the detection range.

7. The system according to claim 1, wherein the processor outputs information indicating a position and/or a direction of the target based on the entry of the target into the detection range.

8. A device comprising:
a processor that is configured to:
set a detection range for a target on an image acquired from an imaging device provided at a movable body;
detect a change in a posture of the imaging device or the movable body;
detect entry of the target into the detection range; and
output the image and the detection range, wherein
the processor changes the detection range on the image based on the change in the posture of the imaging device or the movable body.

9. A computer-executable method for detecting a target approaching a movable body, the computer-executable method comprising:
setting a detection range for the target on an image acquired from an imaging device provided at the movable body;
detecting a change in a posture of the imaging device or the movable body;
detecting entry of the target into the detection range;
outputting the image and the detection range; and
changing the detection range on the image based on the change in the posture of the imaging device or the movable body.

10. A non-transitory computer-readable medium storing instructions that, when executed by a computer, cause a computer to perform:
setting a detection range for a target on an image acquired from an imaging device provided at the movable body;
detecting a change in a posture of the imaging device or the movable body;
detecting entry of the target into the detection range;
outputting the image and the detection range; and
changing the detection range on the image based on the change in the posture of the imaging device or the movable body.
